(19) United States
(12) Patent Application Publication
(10) Pub. No.: US 2020/0293155 A1
(43) Pub. Date: Sep. 17, 2020

(54) DEVICE AND METHOD FOR PROVIDING REACTIVE USER INTERFACE

(71) Applicant: BLUE HOLE, INC, Gyeonggi-do (KR)

(72) Inventor: Jaechan SHIN, Seongnami-si, Gyeonggi-do (KR)

(21) Appl. No.: 16/082,100

(22) PCT Filed: Mar. 3, 2017
(86) PCT No.: PCT/KR2017/002346

§ 371 Date: Sep. 4, 2018

(30) Foreign Application Priority Data
Mar. 4, 2016 (KR) 10-2016--0026177

(51) Int. Cl. G06F 3/0482; G06F 3/0488

(52) U.S. Cl. CPC G06F 3/0482; G06F 3/0488

(57) ABSTRACT

Apparatus for providing a reactive user interface, according to the present invention, comprising: a touch recognition module for receiving a user's first signal; a processor module for transmitting a second signal in response to the first signal; and a display module.

### TECHNICAL FIELD

The present invention relates to a device and a method for providing a reactive user interface, and more particularly, to an interface device and a method for providing menu buttons on the screen in response to a user's operating directions or directions of signals inputted by a user.

### BACKGROUND ART

Portable telephones, tablet computers and the like, which are equipped with a typical computer device along with a communication device, have come into wide use. Such portable telephones or tablet computers are frequently used while the user is on the move. Typically, users hold them with their one hand and the other hand is used to touch the screen of the device. Since the operation is performed by touching the screen with one hand or the like, it is often difficult or even impossible to perform input operation for those devices as quickly as typical computer keyboards. There are smart devices that are manufactured in such a size that they can be controlled by either one of both hands. This allows for increasing their portability and for controlling the device by using both hands of the users.

On a mobile phone, a tablet computer, etc., applications are launched by clicking a iconized menu button on the screen, representing the software. While there may be separate menu buttons for controlling an application, once the application is launched, the location where the menu buttons are activated may be limited, when images or the like are main attributes of the application.

On the other hand, in the case of applications for games including simulation games or role-playing games, the games are typically played by entering commands in various ways. In this regard, the term “pinch-to-zoom” is a technical jargon referring to a kind of multi-touch gestures, which enables zooming in or out of images on the screen with the thumb and index finger and also includes dragging the screen up and down with one finger. By using the pinch-to-zoom gesture to scale the game screen, it is possible to overcome some shortcomings of the small screen. However, there still remain some inconveniences in game applications because it is difficult to respond quickly to the user's need for playing games. It is not easy to play such games on smart phones or tablet computers. That is because a keyboard or mouse used in conventional desktop computers cannot be employed on smart phones or tablet computers.

### SUMMARY OF INVENTION

### Technical Problem

In view of the above, an object of the present invention is to provide a device and a method for providing a reactive user interface that reacts with the user's operation methods of such devices.

### Technical Solutions

In accordance with one aspect of the present invention, there is provided a device for providing a reactive user interface comprising: a touch recognition module for receiving a user's first signal; a processor module for transmitting a second signal in response to the first signal sent by the touch recognition module; and a display module comprising a first area and a second area on a screen, wherein when the first signal is received in the first area, the processor module extracts information on an input modes of the first signal, and the processor module transmits preset information corresponding to the extracted information on the input modes as the second signal, and wherein the display module visualizes the information corresponding to the second signal on the second area.

In accordance with one aspect of the present invention, provided is a method for providing a reactive user interface comprising: the steps of receiving a first signal, transmitting a second signal corresponding to the received first signal, and visually representing information corresponding to the second signal.

### Advantageous Effects

As set forth above, according to the present invention, it is possible to improve user convenience by activating a user interface having at least one menu at a position on the screen that a user prefers.

In addition, according to the present invention, it is possible to increase user convenience by providing various menus on the screen in various ways in response to a user's operation methods.

In addition, according to the present invention, it is possible to control a screen quickly and intuitively by using user's gestures or the like.

### BRIEF DESCRIPTION OF DRAWINGS

FIG. 1 is a block diagram for illustrating a reactive user interface system according to an exemplary embodiment of the present invention.

FIG. 2 is a block diagram for illustrating a device for providing a reactive user interface of the present invention.

FIG. 3 is a diagram for illustrating an example of expansion of a smart button along a first path according to the present invention.

FIG. 4 is a diagram for illustrating an example of expansion of a smart button along a second path according to the present invention.

FIG. 5 is a diagram for illustrating an example of movement of a smart button according to the present invention.

FIG. 6 is a diagram for illustrating a display module according to an exemplary embodiment of the present invention

FIG. 7 is a diagram for illustrating an example of editing submenu buttons according to the present invention.

FIG. 8 is a diagram for illustrating an example of a tree structure of submenus according to the present invention.

FIG. 9 is a diagram for illustrating an example of a first visual representation corresponding to the tree structure of submenus according to the exemplary embodiment of the present invention.

FIG. 10 is a diagram for illustrating an example of a second visual representation corresponding to the tree structure of submenus according to the exemplary embodiment of the present invention.

FIG. 11 is a diagram for illustrating an example of a third visual representation corresponding to the tree structure of submenus according to the exemplary embodiment of the present invention.

FIG. 12 is a diagram for illustrating an example of a fourth visual representation corresponding to the tree structure of submenus according to the exemplary embodiment of the present invention.

FIG. 13 is a flow chart for illustrating a method for providing a reactive user interface according to an exemplary embodiment of the present invention.

### DESCRIPTION OF EMBODIMENTS

Hereinafter, exemplary embodiments of the present invention will be described in detail with reference to the accompanying drawings. For purposes of simplicity and clarity, detailed descriptions of well-known configurations or functions may be omitted so as not to unnecessarily obscure the gist of the present invention.

As used herein, the terms “unit,” “device,” “part,” “module,” etc. mean unit components for performing at least one function per operation and may be implemented in hardware or software or as a combination of hardware and software.

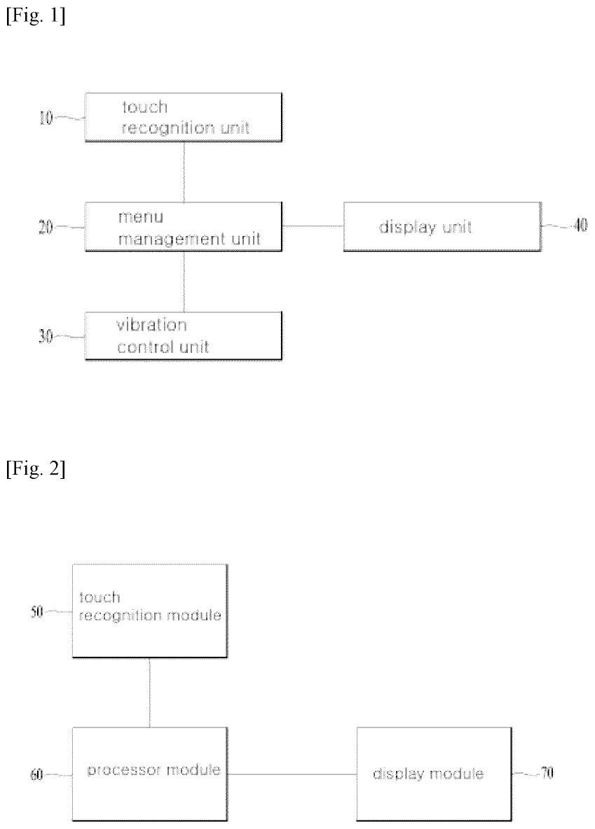

FIG. 1 is a block diagram for illustrating a reactive user interface system according to an exemplary embodiment of the present invention.

Referring to FIG. 1, the user interface system comprises at least one or more of a touch recognition unit 10, a menu management unit 20, a vibration control unit 30, and a display unit 40. The touch recognition unit 10, the menu management unit 20, the vibration control unit 30 and the display unit 40 may be implemented as respective hardware processors, or as a single integrated processor.

The touch recognition unit 10 may be formed integrally with the display unit 40 to which user's touch is applied, as in a smart phone or a tablet computer, so that the user's touch can be intuitively recognized. The touch recognition unit 10 can sense that a menu button on the screen of the display unit 40 is touched and swiped in a certain direction by the user.

The touch recognition unit 10 may determine whether the screen of the display unit 40 is touched by the user for a predetermined period of time, and if it is determined that a touch has been maintained for the predetermined period of time, a menu button may be displayed on the screen. The touch recognition unit 10 may recognize that the displayed menu button being in touch is swiped in any of the upward, downward, left and right directions with respect to the vertical direction of the screen of the display unit 40. The touch recognition unit 10 may set additional directions on the screen in which the menu button may be swiped as desired by combining the four directions.

When the touch recognition unit 10 recognizes that the menu button being in touch is swiped by the user, the menu management unit 20 to be described later in detail may display submenu buttons that match the swiped directions on the screen of the display unit 40. In addition, as described above, the submenu buttons may be displayed as the user swipes a menu button on the screen of the display unit 40 or as the user simply touches a menu button.

The submenu buttons may be displayed around the touched menu button on the screen of the display unit 40. Then, the script or other menu buttons provided by the device or application may be hidden by the submenu buttons. In other words, the submenu buttons may be located at the highest layer.

The touch recognition unit 10 may also recognize whether or not the display unit 40 is touched by the user for more than a predetermined period of time. When the touch recognition unit 10 recognizes that a submenu button swiped to a position is touched by the user for a predetermined period of time, the menu management unit 20 may display lower level submenu buttons on the screen of the display unit 40. That is to say, menu buttons subordinate to a menu button may be displayed according to the user's touch pattern and time.

When a displayed menu button is touched by the user for more than a predetermined period of time, the menu management unit 20 may control the way that the menu button is displayed. This is to draw the user's attention to the touching time. The menu button may be made to flicker, shake or rotate, and so on, so that the user realize that the menu button is being touched for more than a certain period of time.

In addition, when it is detected that the submenu buttons are displayed at a position where a notification script or a default menu button is being displayed on the screen of the display unit 40, the menu management unit 20 may control the submenu buttons so that the menu button and the submenu buttons are displayed at a position other than the position where the notification script or the default menu button is displayed.

Further, the menu management unit 20 may control the menu button so that it is moved to a position to which the menu button is dragged by the user. That is to say, when the displayed menu button is touched and held by the user for a predetermined period of time or longer, the menu management unit 20 may control the menu button so that it is moved to a position selected by the user. More specifically, the selected position may be a position to which the user has dragged the menu button on the screen of the display unit 40.

However, the position selected by the user is not limited to the dragged position and may be determined as desired. This is to allow the user to see whether submenu buttons, subordinate to the menu buttons, are correctly selected.

The vibration control unit 30 may impart vibration to the device when the menu button is displayed. Accordingly, the user can confirm that the menu button has been activated on the screen by the vibration, even without watching it.

The display unit 40 may recognize the user's touch when the user touches the displayed menu directly. It is, however, to be understood that the present invention is not limited thereto. The display unit 40 may recognize the user's touch on any part of the device within the scope of the present invention as long as the user's touch can be made by the touch recognition unit 10 of the device.

Typically, the display unit 40 faces the user. The user may be able to use the device by grabbing the opposite face of the display unit 40. In doing so, the user may grab the device such that the user can freely move the index finger or the middle finger.

In this case, although not shown in the drawings, the above-described touch recognition unit 10 may be located on a part of or the entire opposite face of the display unit 40 of the device, such that it recognizes the user's touch and allows the user to select a menu displayed on the display unit 40. With this configuration, it is possible to create menu buttons and input necessary information more quickly, and to prevent the display unit 40 from being hidden by the user's fingers or the like.

In addition, the way of directly touching the surface of the screen of the display unit 40, like the way how the touch recognition unit 10 senses that a menu button on the screen of the display unit 40 is touched and then swiped in a certain direction, may be used likewise to the opposite surface of screen of the display unit where the touch recognition unit 10 is disposed on a part of or the entire surface thereof.

Further, the display unit 40 may display submenu buttons according to the swipe directions as the user touches and swipes a menu button. At this time, submenu buttons may be arranged differently depending on the swipe directions. That is to say, the display unit 40 may arrange submenu buttons differently for different swipe directions. This is configured in consideration of the fact that different users may have different preferences for their swiping directions.

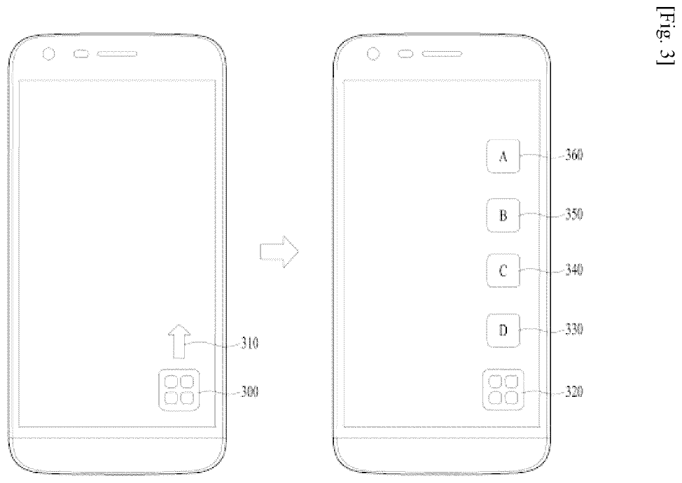

The display unit 40 may recognize that the user touches a menu button and swipes it in upward, downward, left or right direction with respect to the vertical direction of the display unit 40. The display unit 40 may set additional directions in which the menu button is to be swiped as desired by combining the four directions. When the display unit 40 recognizes that the user has performed a swipe operation, the menu management unit 20 may display the submenu buttons that match the particular direction, on the screen of the display unit 40. The menu button described above may be a smart button 120 (see FIG. 2) to be described later in detail. In other words, the above-described menu button may be replaced with a smart button.

FIG. 2 is a block diagram for illustrating a device for providing a reactive user interface according to the present invention.

Referring to FIG. 2, the device for providing a reactive user interface comprises a touch recognition module 50, a processor module 60 and a display module 70. The touch recognition module 50 may correspond to the touch recognition unit 10 described above with respect to FIG. 1. In addition, the processor module 60 may correspond to the menu management unit 20, having some functions of the touch recognition unit 10 in FIG. 1. The display module 70 may correspond to the display unit 40 described above with respect to FIG. 1.

The touch recognition module 50 may receive a user input signal for interface operation and transmit it to the processor module 60. The processor module 60 may transmit a display command signal corresponding to the received user input signal to the display module 70. In addition, the display module 70 may display preset information on the display of the device in response to the received display command signal. It is to be noted that although the display module 70 is actually operated by the processor module 60, the display module 70 will be described in a manner that it operates on its own in the following description for convenience of illustration.

The touch recognition module 50 may receive a first signal sent by a user. In addition, the processor module 60 may transmit a second signal in response to the first signal. In addition, the display module 70 may include a first area and a second area. Further, the display module 70 may display the information corresponding to the second signal in the second area. When the first signal is received in the first area, the processor module 60 may extract information about the input type of the first signal. The processor module 60 may transmit preset information, corresponding to the information about the extracted input type, as the second signal.

By the way, the information about the input type of the first signal may include a swipe by the user in the upward direction, a swipe in the downward direction, a swipe in the left direction, a swipe in the right direction, or a swipe in a diagonal direction. In addition, the information about the input type of the first signal may include a touch (click) input that lasts for a predetermined time or longer, a touch input that lasts for a predetermined time or less, or a touch input that is made a predetermined number of times.

In addition, the information to be displayed in the second area may include information about one or more submenu buttons. In addition, the information to be displayed in the first area may include information about a smart button. More detailed description thereof will be made below.

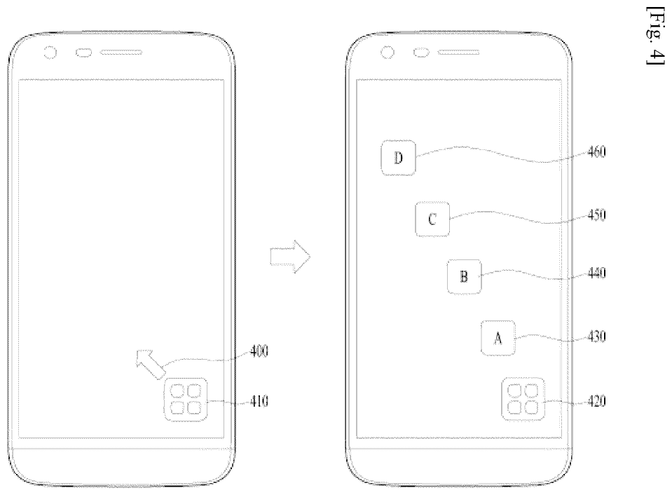

FIG. 3 is a diagram for illustrating an example of a smart button expansion along a first path.

Referring to FIG. 3, the display module 70 displays a smart button 320 on the lower right side of the screen of the device. When the smart button on the screen of the display module 70 is swiped in the direction indicated by an arrow 310, the display module 70 generates submenu buttons A 360, B 350, C 340 and D 330, which are for new menus. More specifically, the touch recognition module 50 transmits the user's input signal for the direction, in which the smart button is to be moved, to the processor module 60, when the user swipes the smart button 320 on the screen of the device in the direction indicated by the arrow.

The processor module 60 may transmit a command signal to the display module 70 so as to display one or more submenu buttons in response to the user's input signal for the direction in which the smart button is to be moved. The command signal to display one or more predetermined submenu buttons may include information about the number of submenu buttons, the direction in which the submenu buttons are displayed, the distance between the displayed submenu buttons, and the distance between the smart button and the submenu buttons. The information included in the above-mentioned display command signal may be altered for the design purpose, and thus not be limited to those described above.

Although not shown in the drawings, the display module 70 may display a preset keyboard or the like instead of the submenu buttons, when the user swipes the smart button on the display module 70 in the direction indicated by the arrow. Configurations of the image or function for each submenu button may be set by the user or provided in advance. It is to be noted that the visual representation or display on the screen of the display module 70 according to the swiping direction of the smart button 320 is not limited to the above-described submenu buttons or keyboard and may be altered according to the design purpose.

FIG. 4 is a diagram for illustrating an example of a smart button expansion along a second path.

Referring to FIG. 4, the display module 70 displays a smart button 410 on the lower right side of the screen of the device. When the smart button on the display module 70 is swiped in the diagonal direction as indicated by the arrow, i.e., a second path 400, the display module 70 generates submenu buttons A 430, B 440, C 450 and D 460, which are for new menus. More specifically, the touch recognition module 50 transmits the user's input signal for the direction, in which the smart button is to be moved, to the processor module 60, when the user swipes the smart button 410 or 420 on the screen of the device in the direction as indicated by the arrow 400.

The processor module 60 may transmit a command signal to the display module 70 so as to display one or more submenu buttons in response to the user's input signal for the direction in which the smart button is to be moved. The command signal to display one or more predetermined submenu buttons may include information about the number of submenu buttons, the direction in which the submenu buttons are displayed, the distance between the displayed submenu buttons, and the distance between the smart button and the submenu buttons. The information included in the above-mentioned display command signal may be altered for the design purpose, and thus not be limited to those described above.

Although not shown in the drawings, the display module 70 may display a preset keyboard or the like instead of the submenu buttons, when the user swipes the smart button on the screen of the display module 70 in the diagonal direction as indicated by the arrow. The configurations of image or function of each submenu button may be set by the user or provided in advance. It is to be noted that the graphical representation or display on the display module 70 according to the swiping direction of the smart button 420 is not limited to the above-described submenu buttons or keyboard and may be altered according to the design purpose.

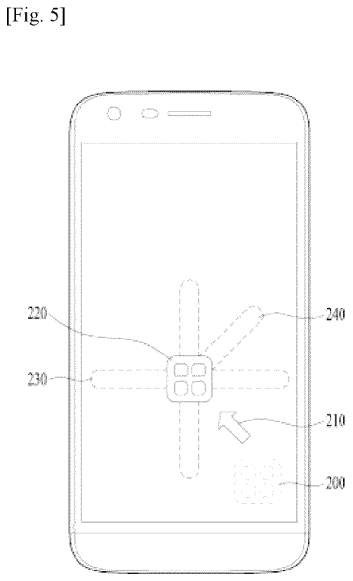

FIG. 5 is a diagram for illustrating an example of smart button movement.

Referring to FIG. 5, the display module 70 displays a smart button 200 or 220 on the lower right side of the screen of the device. In addition, the display module 70 may visualize the moving paths 230 and 240 of the smart buttons 220 for the expansion of submenu buttons described above.

The above-described display module 70 may visualize the moving paths of the smart button 220 on the screen of the display module 70 in a relief or counter-relief pattern depending on the user's setting. The display module 70 may, however, not visualize the moving paths of the smart button 220 on the screen of the device according to the user's setting.

The touch recognition module 50 may transmit an input signal for smart button movement to the processor module 60, when the touch recognition module 50 continuously receives the user input signal for the smart button 200 for the predetermined period of time (that is, when the user presses the smart button 200 for a predetermined period of time and moves it in a desired direction 210 or to a desired location 220).

The processor module 60 may move the smart button 200 shown on the lower right side of the screen of the device to the center of the screen of the device in response to the received input signal for the smart button movement. In addition, the display module 70 may also visualize the movement of the smart button by the processor module 60.

The touch recognition module 50 may transmit a first movement input signal for the smart button or a second movement input signal for the submenu buttons to the processor module 60, when the submenu buttons are visualized or activated on the screen of the device, and the touch recognition module 50 continuously receives the user input signal for the smart button for the predetermined period of time (that is, when the user presses the smart button 200 for a predetermined period of time and moves it in a desired direction 210 or to a desired location 220).

The processor module 60 may also move only the smart button in response to the received first movement input signal or the smart button as well as the submenu buttons in response to the first and second movement input signals.

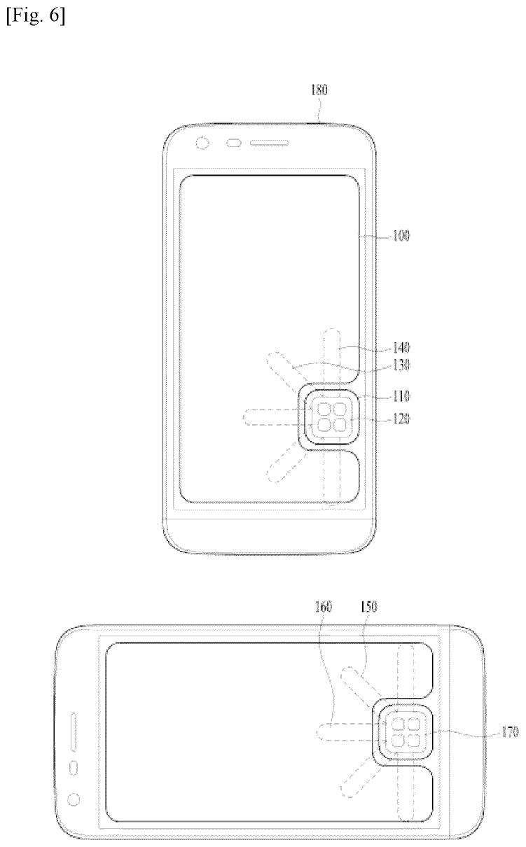

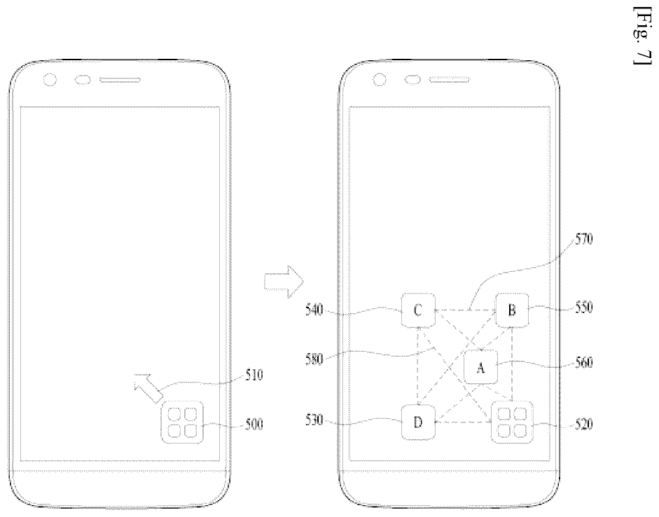

FIG. 6 is a diagram for illustrating a display module according to an exemplary embodiment of the present invention.

Referring to FIG. 6, the screen of the display module 70 is configured to have a first area 110 and a second area 100. The first area may show smart buttons 120 and 170. The above-described submenu buttons may be displayed in the second area 100 described above.

In addition, the display module 70 may display on the first area 110 and the second area 100 differently in response to user input signals inputted to the first area 110 and the second area 100, respectively.

Further, the display module 70 may visualize the moving paths 130, 140, 150 and 160 of the smart button 120 or 170 for expansion of the submenu buttons described above. As described above, the display module 70 may visualize the moving paths of the smart button 120 or 170 on the display module 70 in a relief pattern (or counter-relief pattern) or may not visualize them on the display of the device 180 according to the user's setting.

The processor module 60 may transmit a command signal to expand submenu buttons to the screen of the display module 70, only when the touch recognition module 50 receives a user input signal corresponding to the moving paths 130, 140, 150 and 160 of the smart button 120 or 170.

The display module 70 may visualize preset information including game information in the first area and the second area in addition to the above-described smart buttons and submenu buttons. It is to be noted that the above-described game information may be altered according to the intention of designers and thus is not limited to that described above.

The screen of the display module 70 may include a plurality of layers and may display preset information such as the game information at the first layer, information about the submenu buttons at the second layer, or information about the smart button at the third layer. In addition, the above-described third layer is the highest layer, and the display module 70 may display the information about the smart button displayed at the third layer such that it may not be overlapped with the first layer and the second layer. Further, the above-described second layer is the second highest layer, and the display module 70 may display the information about the submenu buttons displayed at the second layer such that it may not be overlapped with the first layer.

The display module may display preset information on a part of or the entire surface of the display module, in the case that the touch recognition module recognizes no user input signal for a predetermined period of time.

Specifically, when the game is being displayed on the screen of the device, and the touch recognition module recognizes no user input signal for a predetermined period of time, the display module may display preset information on a part of or the entire surface of the screen of the device.

The display module may stop displaying the preset information, when the touch recognition module recognizes the user input signal while the preset information is being output. The above-described preset information may be a plurality of pieces of information, which may appear and disappear sequentially on the screen.

The preset information may include a variety of pieces of information such as advertisements, news in games, other user's activities, etc. It is to be noted that the above-described information may be altered according to the design purpose and thus not be limited to that described above.

In addition, unlike those described above, the user input signals may include at least one of a physical button input signal, a tilt input signal, and a position movement input signal, in addition to the touch input signal. Specifically, if no tilt input signal is received for predetermined period of time, the display module may display preset information as described above.

Further, when the touch recognition module receives a signal for a preset user input type, the display module may visualize information corresponding to the signal for the user input type.

The above-described second area may have area A and area B on the lower right side of the screen of the device with respect to the area A, and area C on the lower left side of the screen of the device with respect to the area A. The above-mentioned area A, area B and area C on the screen of the device may not be wholly activated for providing images, and thus they may be activated for providing images in a preset size and at different positions therein. In addition, only one or two of the areas A, B, and C on the screen of the device may be activated for providing images.

When the display module activates only the area A, or activates the area A at the center of the second area with the areas B and C at preset positions in a preset size for providing images, the display module may be made to visualize the information about the area B on the entire screen or may enlarge it to a preset size, by touching twice the lower right side of the screen of the device.

When the display module activates only the area A or activates the area A at the center of the second area with the areas B and C at preset positions in a preset size for providing images, the display module may be made to visualize the information about the area C on the entire screen or may enlarge it to a preset size, by touching the lower left side of the screen of the device for a longer time.

Alternatively, when a signal for a preset user input type is made by a gyro sensor (that is, when the device recognizes that it is tilted in the three-dimensional space), and the processor module recognizes the direction of the tilting (tilting of the device by the gyro sensor), the display module may be made to visualize the information about the area B or C on the entire screen or may enlarge it to a preset size, corresponding to the direction toward which the device is tilted from the area A.

Alternatively, when a signal for a preset user input type is made by tapping the device, the processor module may count the number of tapping, and visualize the information about the area B or C on the entire screen or may enlarge it to a preset size, based on the counted number of tapping.

The preset sizes, the methods of visual representations and the preset user input types for areas A, B and C may be altered as the designer desires, and thus not be limited to those described above.

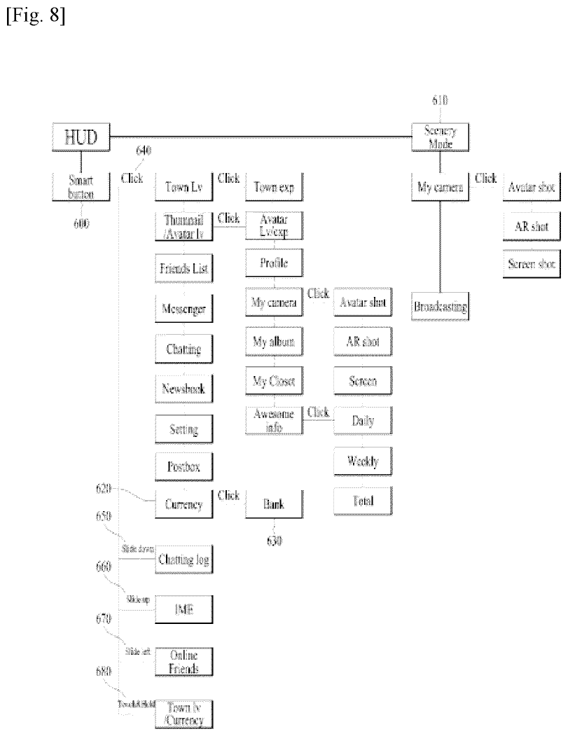

FIG. 7 is a diagram for illustrating an example of editing submenu buttons according to the present invention.

FIG. 7 illustrates expansion along the second path of the smart button according to another exemplary embodiment of the present invention, different from the exemplary embodiment shown in FIG. 4. To this end, the device for providing a reactive user interface according to this exemplary embodiment of the present invention may further include a menu editing module (not shown in FIG. 2).

The touch recognition module 50 may transmit the user's input signal for the direction, in which the smart button is moved, to the processor module 60, when the user swipes the smart button 500 or 520 on the screen of the device in the direction as indicated by the arrow 510. In addition, the processor module 60 may request the menu editing module for the information on the first and second distances described above. Further, the menu editing module may transmit the information on the first and second distances to the processor module 60 in response to the user's input signal for the direction in which the smart button is to be moved.

By the way, the processor module 60 may transmit a command signal to display one or more submenu buttons to the display module 70 based on the received first and second distance information. The display module 70 may visualize one or more submenu buttons A 560, B 550, C 540 and D 530 in response to the display command signal.

In more detail, the menu editing module may set the first distance information 580 between the smart button 520 and the submenu buttons or the second distance information 570 between the submenu buttons. For example, the menu editing module may set the first distance information 580 and the second distance information for the smart button 520 and submenu buttons based on the information directly inputted by the user. The menu editing module may also set the first distance information 580 and the second distance information by means of the user's successive touching(swiping) of the screen of the device or the user's inputting of individual values including numerical information. However, the input type may be altered as intended by the designer and thus not be limited to those described above.

Further, the menu editing module may set multiple separation distance information (first distance information) between the smart button and the each of the submenu buttons. The menu editing module may also set single separation distance information (first distance information) between the smart button and the submenu buttons. In the case of the latter, the smart button and the submenu buttons may be arranged to be shown in the form of arc or fanwise.

The menu editing module may set multiple separation distance information (second distance information) between the submenu buttons as well. The menu editing module may set single separation distance information (second distance information) between the submenu buttons.

When the smart button 520 and the submenu buttons are visualized, if the touch recognition module 50 recognizes an input signal for the smart button or submenu buttons for a predetermined period of time, the processor module 60 may activate the edit mode of the smart button or the submenu buttons.

By the way, the menu editing module may store the modified first and second distance information, and the coordinate information of the smart button or individual submenu buttons, when the smart button or submenu buttons in the edit mode have been moved in response to the successive input of signals from the user on the screen of the device. It is to be noted that the menu editing module described above may calculate the first and second distance information based on the coordinate information of the smart button and the submenu buttons on the display module.

Further, the processor module may automatically move the submenu buttons based on the multiple or single distance information in response to the movement of the smart button, when multiple separation distance information (first distance information) between the smart button and each of the submenu buttons or single separation distance information (first distance information) is set by the menu editing module. In addition, the display module may visualize the above-described movement of the smart button and the submenu buttons.

Further, the processor module may automatically move the submenu buttons based on the multiple separation distance information between the submenu buttons in response to the movement of the first submenu among the submenu buttons, when multiple separation distance information (second distance information) between the submenu buttons are set by the menu editing module. In addition, the display module may visualize the above-mentioned movement of each of the submenu buttons.

FIG. 8 is a diagram for illustrating an example of a tree structure of submenus according to the present invention.

Referring to FIG. 8, the display module may visualize the submenus associated with the information on the messenger, chatting, currency or setting on the second area of the screen as described above with reference to FIG. 6, when the touch recognition module recognizes a click input signal 640 on a smart button 600. In addition, the above-described submenus may further have their own lower level submenu(s). Specifically, when the touch recognition module recognizes a click input signal on the submenu associated with the currency information, the display module visualizes a lower level submenu button 630 associated with the bank information in the second area on the screen described above with reference to FIG. 6.

In addition, when the touch recognition module may recognize a swipe input signal that the user swipes the smart button 600 in the downward direction (slide down) 650, the display module may visualize, for example, a lower level submenu associated with the chatting log information in the second area on the screen described above with reference to FIG. 6.

Further, when the touch recognition module recognizes a swipe input signal that the user swipes the smart button 600 in the upward direction (slide up) 660, the display module may visualize, for example, a lower level submenu associated with IME information in the second area on the screen described above with reference to FIG. 6.

When the touch recognition module recognizes a swipe input signal that the user swipes the smart button 600 in the left direction (slide left) 670, the display module may visualize, for example, a lower level submenu associated with the online friend information in the second area on the screen described above with reference to FIG. 6.

When the touch recognition module recognizes an input signal that the user presses the smart button 600 for more than a predetermined period of time (touch & hold) 680, the display module may visualize, for example, a lower level submenu associated with town information or currency information in the second area on the screen described above with reference to FIG. 6.

The display module may switch the second area, described above with reference to FIG. 6, into a scenery mode, if the touch recognition module would fail to recognizes any input signal for the smart button 600 for a predetermined time or more.

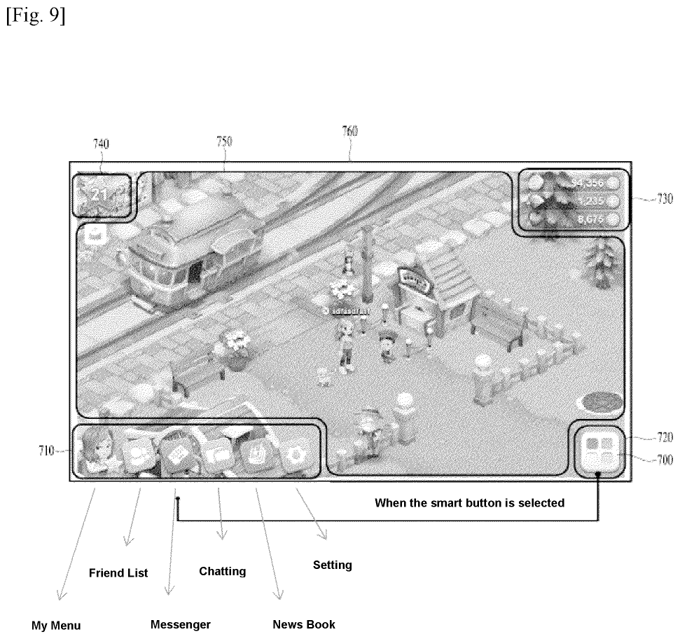

The information that the display module visualizes in response to the input signal recognized by the touch recognition module may be altered according to the intention of the designer, and thus not be limited to that described above. The information to be visualized by the display module in response to a preset submenu tree will be described with reference to FIGS. 9 to 12 hereinbelow.

FIG. 9 is a diagram for illustrating an example of a first visual representation corresponding to the tree structure of submenu buttons according to the exemplary embodiment of the present invention.

Referring to FIG. 9, as described above with reference to FIGS. 6 and 8, when the touch recognition module recognizes a click input signal for the smart button 700 included in the first area 720, the display module may visualize submenu buttons associated with information on My Menu, Friend List, Messenger, Chatting, News Book, or Setting on the lower left side 710 of the second area 760 on the screen described above with reference to FIG. 6, a submenu button associated with the level information on the upper left side 740 of the second area 760 on the screen, and submenu buttons associated with Currency information on the upper right side 730 on the screen. The display module may visualize game play information in the center 750 of the second area 760 on the screen as described above with reference to FIG. 6.

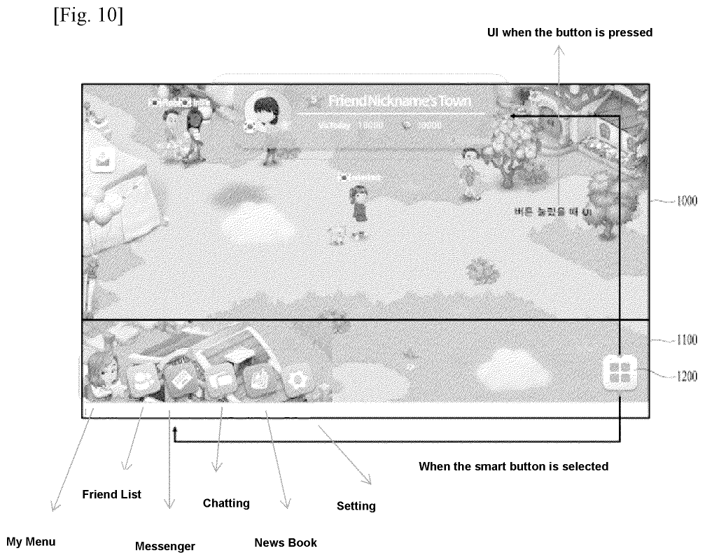

FIG. 10 is a diagram for illustrating an example of a second visual representation corresponding to the tree structure of submenu buttons according to the exemplary embodiment of the present invention.

Referring to FIG. 10, the display module may visualize submenu buttons associated with information on My Menu, Friend List, Messenger, Chatting, News Book, or Setting on the lower left side of the second area 1100 on the screen as described above with reference to FIG. 6, when the touch recognition module recognizes a click input signal for the smart button 1200 as described above with reference to FIG. 8. The display module may subsequently divide the second area on the screen as described above with reference to FIG. 6 and visualize Town information on friends in the second area 1000 on the screen, when the touch recognition module recognizes a click input signal for the smart button 1200 for a predetermined time or longer.

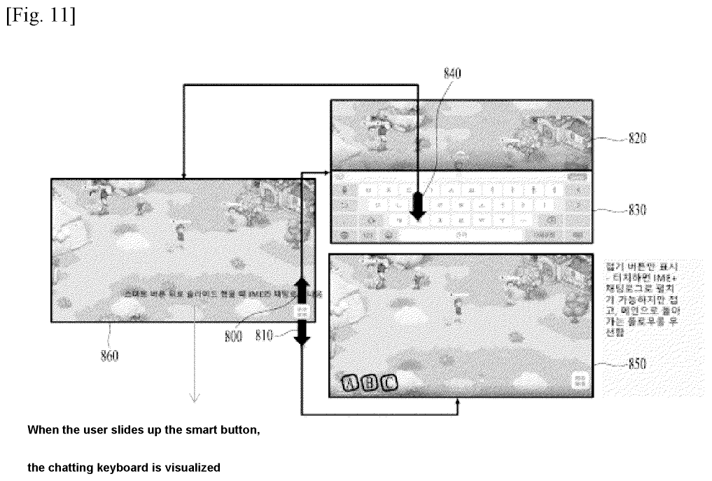

FIG. 11 is a diagram for illustrating an example of a third visual representation corresponding to the tree structure of submenu buttons according to the exemplary embodiment of the present invention.

Referring to FIG. 11, the display module may visualize preset information A, B and C on the lower left side of the second area 850 on the screen described above with reference to FIG. 6, when the touch recognition module recognizes a swipe input signal in the downward direction (slide down) 810 for the smart button.

In addition, the display module may visualize information associated with the submenu such as Chatting Keyboard in the second area 820 on the screen described above with reference to FIG. 6, when the touch recognition module recognizes a swipe input signal for the smart button 600 in the upward direction (slide up) 800. The display module may visualize main mode information set by the user in the second area 860 on the screen described above with reference to FIG. 6, when the touch recognition module recognizes a swipe input signal in the downward direction (slide down) 840 for the smart button, while the submenu associated with the Keyboard information is activated. In other words, the processor module may put visualization of the information on the main mode preset by the user above the visualization of the preset information A, B and C, in response to the swipe input signal (slide down) 810 for the smart button in the downward direction.

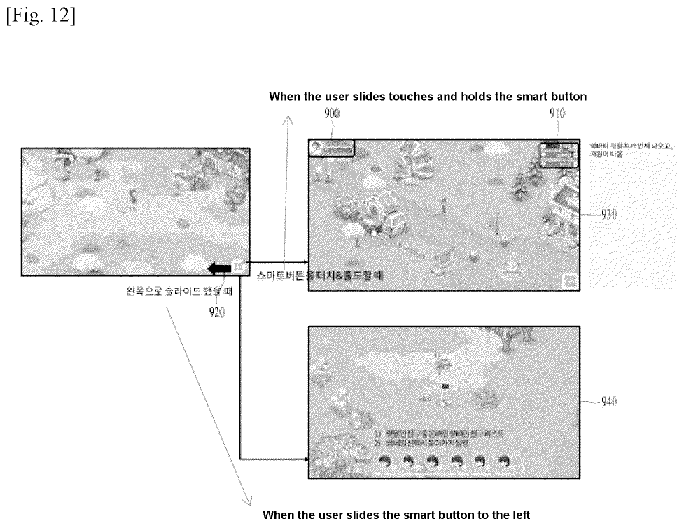

FIG. 12 is a diagram for illustrating an example of a fourth visual representation corresponding to the tree structure of submenu buttons according to the exemplary embodiment of the present invention.

Referring to FIG. 12, the display module may visualize information associated with the submenu such as Online Friend in the second area 940 on the screen described above with reference to FIG. 6, when the touch recognition module recognizes a swipe input signal that the user swipes the smart button 600 in the left direction (slide left) 920.

The display module may visualize information associated with the submenu such as Avatar on the upper left side of the second area 930 on the screen described above with reference to FIG. 6 and information associated with the submenu such as Currency on the upper right side on the screen, when the touch recognition module recognizes an input signal that the user presses the smart button 600 for more than a predetermined period of time (touch & hold).

It is to be noted that the information displayed in FIG. 8 and the information displayed in FIG. 12, each corresponding to the respective input signals (touch & hold) for more than a predetermined period of time for the smart button are different from each other, but that is to show that settings can vary as the designer desires.

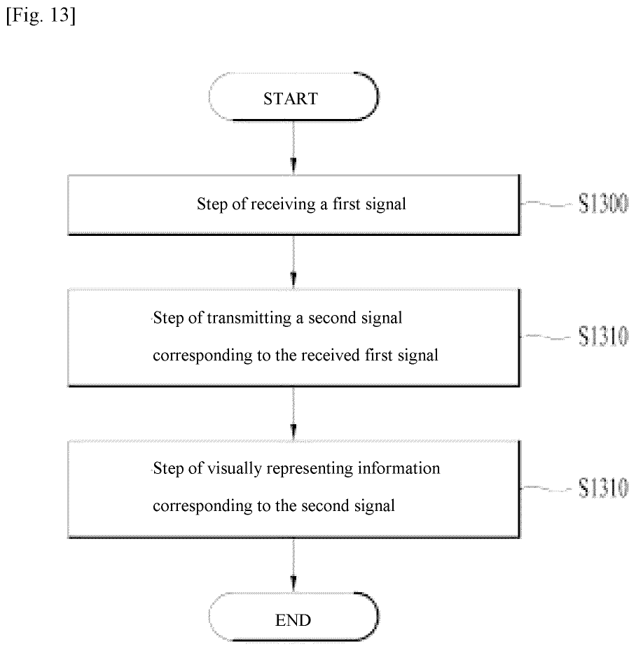

FIG. 13 is a flowchart for illustrating a method for providing a reactive user interface according to an exemplary embodiment of the present invention.

Referring to FIG. 13, the method for providing a reactive user interface comprises the steps of receiving a first signal (step S1300), transmitting a second signal corresponding to the received first signal (step S1310), or visualizing information corresponding to the second signal (step S1320). The touch recognition module 50 may perform the step S1300 of receiving the first signal. A detailed description thereof has been given above with reference to FIGS. 1 to 12. In addition, the processor module 60 may perform the step S1310 of transmitting the second signal corresponding to the received first signal. A detailed description thereof has been given above with reference to FIGS. 1 to 12. Further, the display module 70 may perform step S1320 of visualizing information corresponding to the second signal. A detailed description thereof has been given above with reference to FIGS. 1 to 12.

The exemplary embodiments described herein are merely illustrative and are not intended to limit the scope of the present invention. The scope of protection sought by the present invention is defined by the appended claims and all equivalents thereof are construed to be within the true scope of the present invention.

### INDUSTRIAL APPLICABILITY

As described above, according to the present invention, it is possible to provide a reactive user interface with which the user convenience is enhanced.

What is claimed is:

1. A device for providing a reactive user interface comprising:
a touch recognition module for receiving a user's first signal;
a processor module for transmitting a second signal in response to the first signal sent by the touch recognition module; and
a display module comprising a first area and a second area on a screen, wherein when the first signal is received in the first area, the processor module extracts information on an input modes of the first signal, and the processor module transmits preset information corresponding to the extracted information on the input modes as the second signal, and wherein the display module visualizes the information corresponding to the second signal on the second area.
